(19) United States
(12) Patent Application Publication
(10) Pub. No.: US 2005/0246536 A1
(43) Pub. Date: Nov. 3, 2005

(54) Embedding of image authentication signatures

(76) Inventor: David Keith Roberts, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/518,266

(22) PCT Filed: Jun. 12, 2003
(86) PCT No.: PCT/IB03/02629

§ 371 Date: Dec. 16, 2004

(30) Foreign Application Priority Data
Jun. 28, 2002 (NL) 1020955

(51) Int. Cl. H04L 9/00

(52) U.S. Cl. 713/176

(57) ABSTRACT

A method (2), an apparatus, a computer readable medium and use of said method for authenticating an audio-visual signal (10), such as a digital image or video, are disclosed. A signature is derived from all image regions, including areas with flat or otherwise un-watermarkable content. By combining signature bits from all regions of the audio-visual signal and spreading the signature bits over the whole audio-visual signal or at least a large area of it, preferably by applying a spread spectrum watermarking technique (2.40), the authenticity of flat regions is verified.

### FIELD OF THE INVENTION

This invention relates in general to the field of signal authentication and more particularly to the embedding of signatures in an audio-visual signal for authentication of images and video.

### BACKGROUND OF THE INVENTION

The success of digital imaging and video has lead to a wide use of this technology in many fields of everyday life. Technology to edit, alter or modify digital images or video sequences is commercially available and allows modifications of the contents of these audio-visual signals without leaving traces. For a variety of applications, such as evidential imaging in law enforcement, medical documentation, damage assessment for insurance purposes, etc., it is necessary to ensure that an image or video has not been modified and is congruent with the image or video originally taken. This led to the development of image or video authentication systems for which an example is shown in FIG. 1, wherein a signature or a watermark is created at 1.20 for a digital signal, i.e. an image or video, which is acquired in 1.10. The signature is embedded at 1.30 in the digital image or video. Thereafter the image or video is processed or tampered in 1.40, played, recorded or extracted in 1.50 and finally verified in 1.60 in order to either ensure that the authenticity of the digital image or video is proven or that modifications of the digital image or video are revealed. For authentication to be possible, the signature derived from the original image must be available. In some applications the signature may be handled as ‘meta-data’ i. e. there is a separate channel available for the transmission and/or storage of the signatures in addition to the image/video channel itself. However, in many applications no such extra channel exists. In these circumstances the signature may be embedded into the images themselves using a watermark.

The amount of signature bits being embeddable is determined in that the audio-visual signal with a signature embedded shall be visually indistinguishable from the original audio-visual signal. Embeddability is often determined by a human visual model and with a perceptual threshold it is defined whether a desired payload is embeddable, i.e. the audio-visual signal with a signature embedded is visually indistinguishable from the original audio-visual signal, or if the payload is unembeddable, i.e. the audio-visual signal with a signature embedded is visually distinguishable from the original audio-visual signal.

Authentication of an audio-visual signal in this context is defined as validating the authenticity of an audio-visual signal, i.e. to verify the perceptual contents of an audio-visual signal such as a digital image or video as being congruent with that of the audio-visual signal originally captured.

Audio-visual signals such as digital images or video to be authenticated may contain smooth regions with flat contents, i.e. regions with little or no image characteristics such as edges, textures or the like. No payload is embeddable in such smooth regions as any changes within a smooth region will be perceivable as a modification or distortion within the smooth region. Therefore it is not possible to embed signature bits in smooth regions. However, a need exists to validate the authenticity of images containing smooth regions with flat contents as it is desired to be able to accurately detect and localise tampering within an audio-visual signal, i.e. even of regions with flat contents.

Fragile watermarking techniques for authentication operate by embedding a watermark into all areas of the audio-visual signal. Regions in which the presence of the watermark can later be detected are judged as authentic, and areas where the watermark cannot be detected are declared as having been altered. The flaw with this approach is caused by regions with flat content. Under the proviso that the watermark should be invisible, it is virtually impossible to embed enough watermark energy into flat regions to enable them to be authenticated, as mentioned above. This is particularly true if the image undergoes allowable operations, such as compression or noise removal, between watermark embedding and authenticity verification.

Furthermore, if a forger replaces in an apparently authentic audio-visual signal, such as a digital image, true content by flat content, there is no way to tell whether watermark detection failure in an image region occurs because the image content was originally flat, or because the true image content has been replaced by flat content. Therefore, any such tampering cannot be detected by a fragile watermarking approach. Authentication schemes that are based upon embedding a signature typically comprise the following steps:
1. Dividing the audio-visual signal into blocks of a certain size, e.g. 64×64 pixels
2. Generate some signature bits for each block
3. Embed the signature bits into the block from which they were generated.

Flat image regions cause this approach the same problems as for fragile watermarking: Firstly, it is not possible to successfully embed and extract signature bits from blocks containing flat content. Secondly, it is not possible to distinguish whether an area from which no signature bits can be extracted was originally flat content, or if the flat content is the result of tampering.

A small step is made in the direction of solving the above problems in M. Wu, B. Liu, “Watermarking For Image Authentication”, Proc. ICIP '98, Chicago, October 1998, wherein each signature bit is embedded in a digital image in two spatially separate locations by ‘backup embedding’. The backup embedding location is identified deterministically and has a fixed spatial relation to the original embedding location. Thus, when both chosen embedding locations contain flat content, the block's signature bits cannot be extracted when validating the authenticity of the digital image. Furthermore, in case that a region of the image containing the backup block for a smooth area is tampered, the smooth area can no longer be authenticated, thus tampering of one are of an image prevents authentication of a completely different area. The problems caused by flat content as outlined above are therefore not solved by the cited disclosure.

Thus, the problem to be solved by the invention is defined as how to provide reliable authentication of audio-visual signals containing areas with flat contents.

### SUMMARY OF THE INVENTION

The present invention overcomes the above-identified deficiencies in the art and solves the above problems by providing watermark embedding by which each signature bit is spread over the whole image, or at least over a large area of it, according to the appended independent claims. The signature derives bits from all image regions, including areas with flat or otherwise un-watermarkable content, thus enabling authentication of all image regions. The embedding of the watermark is done so as to achieve the best trade-off between payload size, robustness, and visibility. The technical effect thus achieved is that signature bits of all image areas can be extracted, even if the original content is flat or has been replaced by tampering. Moreover, the embedding method becomes independent of the signature generation.

According to embodiments of the invention, a method, an apparatus, and a computer-readable medium for authenticating an audio-visual signal are disclosed whereby a signature is generated for at least a first region of an audio-visual signal. Said signature is embedded in said audio-visual signal by spreading bits of said signature over a portion of said audio-visual signal, said portion being larger than said first region.

### BRIEF DESCRIPTION OF THE DRAWINGS

Preferred embodiments of the present invention will be described in the following detailed disclosure, reference being made to the accompanying drawings, in which

FIG. 1 shows a Prior Art authentication system;

FIG. 2 shows a preferred embodiment of the invention;

FIG. 3 illustrates an apparatus according to another embodiment of the invention; and

FIG. 4 illustrates a computer readable according to still another embodiment of the invention.

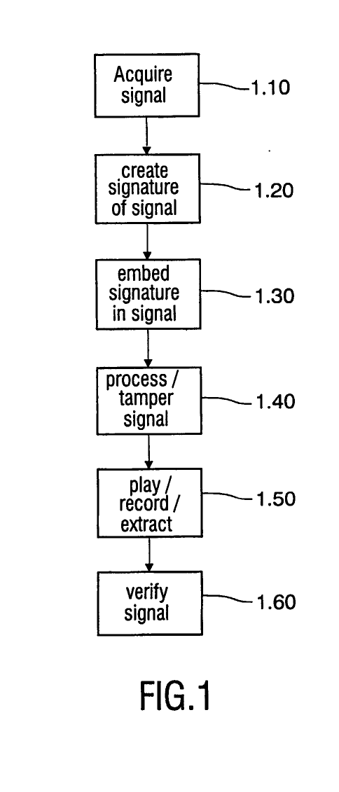

### DESCRIPTION OF PREFERRED EMBODIMENTS

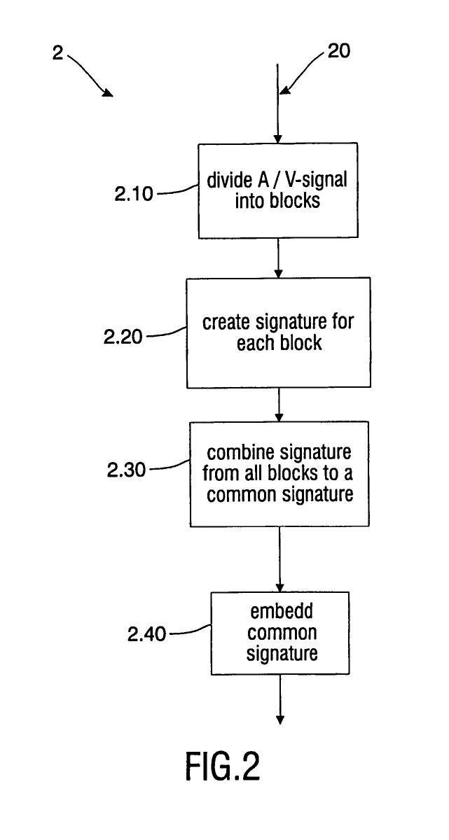

In a preferred embodiment of the invention according to FIG. 2, signature bits are derived in 2.20 for image blocks generated in 2.10 in a method 2 for embedding a signature in an audio-visual signal 20 containing flat regions in a method for authenticating said audio-visual signal 20. A watermarking scheme is then employed in 2.40 by using the combined signature bits of all blocks from 2.30 to generate a watermark embedding the signature bits spanning the whole image, by using, for example, a spread spectrum watermark. The combined signature generated in 2.30 contains bits from all image regions as the whole image is divided into blocks in 2.10 and signature bits are calculated in 2.20 for each block. By using a spread spectrum watermark, signature embedding is concentrated into distortions in regions of the audio-visual signal where they are the least perceptible to human eyes, and leaves flat regions relatively unchanged. This allows signature bits for all regions to be extracted, regardless of whether their content is flat or not. A suitable example for a spread spectrum watermarking technique is disclosed in T. Kalker et. al “A Video Watermarking System for Broadcast Monitoring”, SPIE Security and watermarking of multimedia contents, San Jose, January 1999. The watermarking technique disclosed, called JAWS (Just Another Watermarking Technique), embeds a number of noise patterns into the image, and encodes payload data which in this case are the signature bits as relative translational shifts between the noise patterns. With JAWS it is not possible to identify a spatial location in which a particular bit is embedded; in effect each bit is spread over the image. JAWS is a special case of decomposing the payload bits, in this case the signature bits, such that information needs to be extracted from multiple areas, or a single large area, in order to evaluate the original signature bits. JAWS spread spectrum embedding represents the limit where each and every signature bit is decomposed, i.e. spread, over each and every image pixel.

Alternatively to embedding the signature bits by a spread spectrum watermark, the signature bits might be embedded in another embodiment by embedding each signature bit multiple times in different locations, whereby the locations need not to have a fixed relationship to each other or to the original location of the region containing flat contents. The locations are preferably determined based on the contents of the audio-visual signal and signature bits are embedded preferably in regions with sufficient image characteristics such as edges, textures or the like, in order to ensure that the audio-visual signal with a signature embedded is as less visually distinguishable from the original audio-visual signal as possible. The authenticity of flat regions is verified by the signature bits for such regions which are correctly extracted if a spread spectrum watermarking technique such as JAWS is used. If signature bits are embedded back into the block they were derived from, and invisibility maintained, then in flat blocks the signature bits cannot be reliably extracted. It is then not known whether the signature errors are due to tampering or the original content being flat. Thus it is detected and proven tampered when a forger has replaced original content in an area of an audio-visual signal with flat content.

Each signature bit is preferably spread over as much of the image as possible. This makes the use of spread spectrum watermarking techniques eminently suitable for embedding signatures. In addition, spread spectrum watermarks, such as the above-mentioned Philips' JAWS technique also have good robustness. As long as a sufficient portion of the image remains untampered, then such a technique permits the recovery of the signature bits from the watermark.

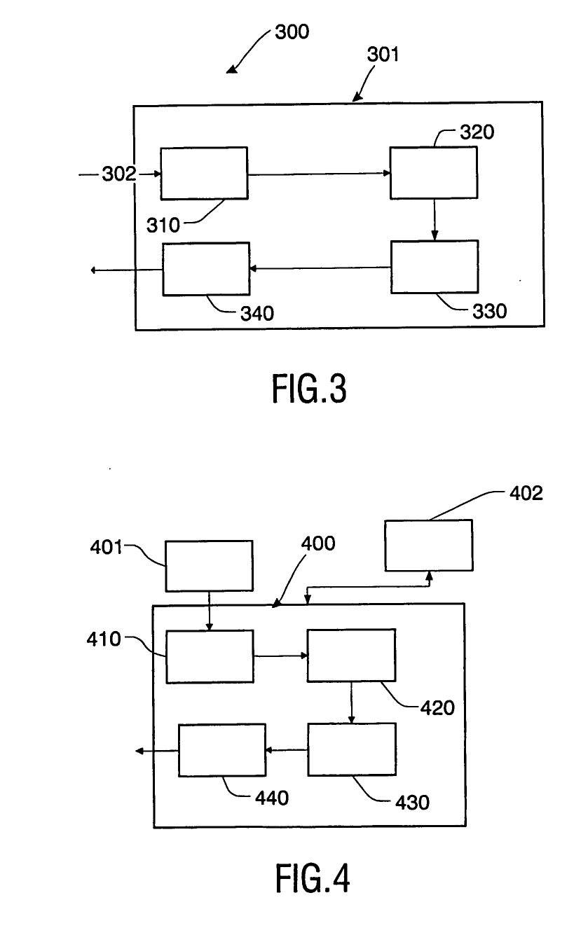

In another embodiment of the invention according to FIG. 3, an apparatus 301 for embedding a signature in an audio-visual signal 302 containing flat regions is provided in a system 300 for authenticating audio visual signals. The audio-visual signal 302 is divided into image blocks by means 310. Signature bits are derived in means 320 for image blocks generated in means 310. Awatermarking scheme is then employed by means 340 by embedding the combined signature bits of all blocks calculated in means 330. The watermark, preferably a spread spectrum watermark, embedds the signature bits spanning the whole image as described above.

A further embodiment of the invention is illustrated in FIG. 4. A computer readable medium 400 for embedding a signature in an audio-visual signal 401 containing flat regions. The audio-visual signal 401 is divided into image blocks by a program module 410 giving instructions to a processor 402. Signature bits are derived in a frther program module 420 for image blocks generated in program module 410. Awatermarking scheme is then employed by program module 440 by embedding the combined signature bits of all blocks calculated in means program module 430.

Applications and use of the above described signal authentication according to the invention are various and include exemplary fields such as
security cameras or surveillance cameras, such as for law enforcement, evidential imaging or fingerprints,
health care systems such as telemedicine systems, medical scanners, and patient documentation,
insurance documentation applications such as car insurance, property insurance and health insurance.

The present invention has been described above with reference to specific embodiments. However, other embodiments than the preferred above are equally possible within the scope of the appended claims, e.g. different field patterns than those described above, performing the above method by hardware or software, etc.

Furthermore, the term “comprising” does not exclude other elements or steps, the terms “a” and “an” do not exclude a plurality and a single processor or other unit may fil the functions of several of the units or circuits recited in the claims.

1. A method of authenticating an audio-visual signal comprising embedding of a signature generated for at least a first region of said audio-visual signal by spreading bits of said signature over a portion of said audio-visual signal, said portion being larger than said first region.

2. A method according to claim 1 whereby said portion is significantly larger than said first region.

3. A method according to claim 1 whereby said signature is embedded as a watermark.

4. A method according to claim 3 whereby the watermark is a spread spectrum watermark.

5. A method according to claim 3 whereby the watermark is embedded according to the best trade-off between payload size of said audio-visual signal, robustness of said watermark and visibility of said watermark.

6. A method according to claim 1 whereby each signature bit is embedded multiple times in different locations within said portion.

7. A method according to claim 1 whereby spreading said signature bits comprises decomposing said signature bits to multiple areas or a single large area within said portion such that information needs to be extracted from said multiple areas or said single large area within said portion, in order to evaluate the original signature bits.

8. A method according to claim 7 whereby said embedding spreads each signature bit over the whole audio-visual signal.

9. A method according to claim 1 whereby said signature comprises combined signature bits for a plurality of regions of said audio-visual signal.

10. A method according to claim 1 whereby the location of said portion has no fixed relationship to said region.

11. An apparatus for authenticating an audio-visual signal comprising a means for embedding a signature in an audio-visual signal according to the method of claim 1 comprising
a means for generating a signature, said signature being generated for at least a first region of said audio-visual signal, and
a means for embedding said signature in said audio-visual signal, whereby said signature is spread over a portion of said audio-visual signal, said portion being larger than said first region.

12. A computer readable medium having a plurality of computer-executable instructions for performing the method according to claim 1 comprising
a first program module generating instructions for a computer for generating a signature, said signature being generated for at least a first region of said audio-visual signal, and
a second program module for generating instructions for a computer for embedding said signature in said audio-visual signal, whereby said signature is spread over a portion of said audio-visual signal, said portion being larger than said first region.

13. Use of the method according to claim 1 in a surveillance camera or security camera or digital image camera or digital video camera or a medical imaging system.
